(19) United States
(12) Patent Application Publication
(10) Pub. No.: US 2026/0044755 A1
(43) Pub. Date: Feb. 12, 2026

(54) OPTIMIZATION OF EXECUTABLE GRAPH FOR ARTIFICIAL INTELLIGENCE MODEL INFERENCE

(71) Applicant: Intel Corporation, Santa Clara, CA (US)

(72) Inventor: Zhengxu Huang, Shanghai (CN)

(73) Assignee: Intel Corporation, Santa Clara, CA (US)

(21) Appl. No.: 18/995,606

(22) PCT Filed: Sep. 2, 2022
(86) PCT No.: PCT/CN2022/116815

§ 371 Date: Jan. 16, 2025

(51) Int. Cl. G06N 5/04

(52) U.S. Cl. CPC G06N 5/04

(57) ABSTRACT

The application relates to optimization of an executable graph for AI model inference. An optimization method may include: duplicating the executable graph to generate a number M of same executable graphs; determining one or more nodes eligible for optimization from the executable graph, based on an inference throughput related parameter associated with an inference device to perform the AI model inference; and generating an optimized executable graph for the AI model inference by optimizing the one or more nodes from each of the number M of same executable graphs. Here, M is an integer in a range of 2 to a maximum number N of allowed executable graphs, and N is an integer manually configured or estimated based on a memory size of the inference device and a size of the executable graph.

### TECHNICAL FIELD

Embodiments described herein generally relate to artificial intelligence (AI) technology, and more particularly relate to a method and an apparatus for optimizing an executable graph for AI model inference.

### BACKGROUND

With rapid development of AI technology these years, more and more outstanding trained models are being deployed to replace traditional algorithms. Even lots of cloud companies have already provided a large variety of AI services for customers. Whether on a local server or a cloud platform, a general inference procedure may include converting a trained model into an executable graph and running the trained model on primitive implementation kernels according to the executable graph. Both the executable graph and the primitive implementation kernels play a critical role in improving inference performance.

### BRIEF DESCRIPTION OF THE DRAWINGS

The various advantages of the embodiments will become apparent to one skilled in the art by reading the following specification and appended claims, and by referencing the following drawings, in which:

FIG. 1 illustrates a general process flow of AI model inference;

FIG. 2 illustrates example nodes with low resource utilization in an executable graph for AI model inference;

FIG. 3 illustrates an optimized process flow of AI model inference according to some embodiments of the present disclosure;

FIG. 4 illustrates an example flowchart of an executable graph optimization procedure according to some embodiments of the present disclosure;

FIG. 5 illustrates an example optimization by merging multiple same nodes from multiple executable graphs to improve instruction utilization according to some embodiments of the present disclosure;

FIG. 6 illustrates a comparison of example dumped assembly codes respectively corresponding to a conventional executable graph with low register utilization and an optimized executable graph with improved register utilization, according to some embodiments of the present disclosure;

FIG. 7 illustrates an example executable graph optimization process implemented by memory management and executable graph modification according to some embodiments of the present disclosure;

FIG. 8 illustrates an example optimized executable graph for AI model inference according to some embodiments of the present disclosure;

FIG. 9 illustrates an example flowchart of an executable graph optimization procedure according to some embodiments of the present disclosure;

FIG. 10 is a block diagram illustrating components, according to some example embodiments, able to read instructions from a machine-readable or computer-readable medium and perform any one or more of the methodologies discussed herein;

FIG. 11 is a block diagram of an example processor platform in accordance with some embodiments of the disclosure.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well-known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

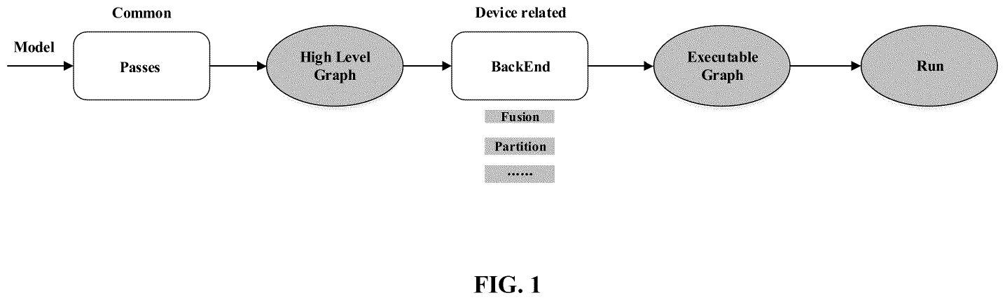

FIG. 1 illustrates a general process flow of AI model inference, which may be implemented on a local server or a cloud platform. As shown in FIG. 1, a trained model may be converted into a high-level graph after a series of transforms and optimization passes. The trained model may be any one of a variety of trained models from different training frameworks (e.g. TensorFlow, PyTorch), and all these transforms and optimization passes are usually device independent. Then the high-level graph may be sent to a device-related backend optimizer to do all kinds of graph optimizations such as fusion, layout change, reorder insertion, primitive kernel selection, partition, memory allocation check, etc. After these optimizations, an executable graph may be generated and output by the device-related backend optimizer. Finally, an inference application may call primitive implementation kernels such as OneDNN according to the output executable graph to perform the AI model inference. It can be seen that both the executable graph and primitive implementation kernels play a critical role in the inference performance.

As the inference is computationally intensive, a workload throughput of the AI model inference is a very important factor affecting market competitiveness of a device (e.g. a central processing unit (CPU), a graphics processing unit (GPU), a tensor processing unit (TPU), a visual processing unit (VPU), or a field programmable gate array (FPGA)) to perform the AI model inference. A theoretical throughput can be obtained from a roofline model or estimated by processing capability (e.g. Tera Operations Per Second (TOPS)) of the device and computational complexity of the AI model. However, the real performance of the AI model inference may be far lower than a theoretical value in actual usage scenarios. In other words, the processing capability of the device to perform the inference may not be fully utilized during actual inference procedures.

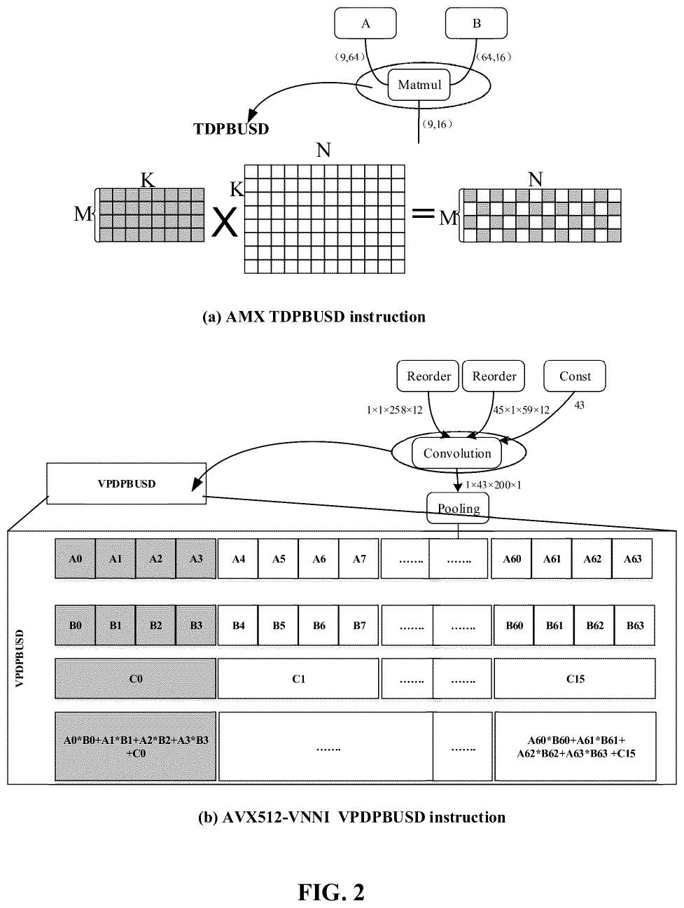

FIG. 2 illustrates example nodes with low resource utilization in an executable graph for AI model inference. As shown in part (a) of FIG. 2, an example node may execute a MatMul operation by use of a Tile Matrix Multiply Unit (TMUL) instruction (e.g. an AMX TDPBUSD instruction). In this example, since a shape of an input matrix A of the node is 9×64, the MatMul operation cannot maximize the utilization of a TMM register supportable by the AMX instruction set. In part (b) of FIG. 2, a node to execute a convolution operation in an executable graph for an INT8 quantized network security model is shown as an example. In this example, when a Vector Neural Network Instructions (VNNI) instruction (e.g. an AVX512-VNNI VPDPBUSD instruction) using the Olhw4i16O4i format is utilized for executing the convolution operation, since the input channel (IC) of the input data of the node is 1 (smaller than 4), the convolution operation cannot fully utilize capability of the VNNI instruction.

From the examples shown in FIG. 2, it can be seen that in actual inference procedures, the processing capability of the device for performing the inference may be not fully utilized and accordingly the inference performance may be lower than an expected performance. Surely, for the second example, it is possible to manually modify implementation of a convolution primitive kernel for this particular case. But if the IC of the input data equals to 2 or 3 other than 1, the implementation of the convolution primitive kernel may need to be modified again. In other words, the implementation of the primitive kernel may need to be modified for lots of special cases and the primitive kernel may be subjected to a variety of special treatments. Likewise, for the first example, special modifications are needed to store enough data for the TMM register and manage partition of the data. An open source primitive kernel tends not to accept these special handling patches as they are completely different from generic processing codes of the kernel, and for each special case, a huge amount of workaround codes have to be added. Therefore, how to improve the throughput of the AI model inference on the device to perform the inference (simply referred to as “inference device” hereinafter) without special modifications to original primitive implementation kernels remains a problem.

According to the present disclosure, a method and an apparatus for optimizing an executable graph for AI model inference are proposed to improve the throughput of the AI model inference by optimizing inference throughput related parameters associated with the inference device, for example, improving an instruction utilization and/or a register utilization, reducing a cache miss rate, etc., without changing generic processing codes of primitive implementation kernels.

As mentioned above, both the executable graph and primitive implementation kernels play a critical role in the inference performance. According to the present disclosure, an advance executable graph optimizer for optimizing an executable graph generated by the common graph optimizer as described with reference to FIG. 1 is proposed to optimize the executable graph based on multiple same executable graphs and the characteristics of the inference device so as to improve the inference performance.

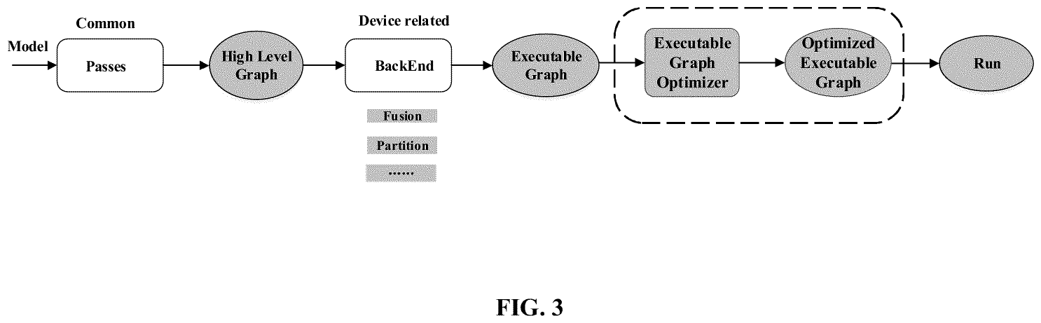

FIG. 3 illustrates an optimized process flow of AI model inference according to some embodiments of the present disclosure. As shown in FIG. 3, the sub-flow in the dashed box may be added into the general flow process of AI model inference as shown in FIG. 1 to obtain the optimized process flow of AI model inference. It is noted that the proposed executable graph optimizer is different from the common executable graph optimizer in that the proposed executable graph optimizer may be configured to duplicate the executable graph generated by the common graph optimizer to generate a number M of same executable graphs, determine one or more nodes eligible for optimization from the executable graph, based on inference throughput related parameters associated with the inference device, and generate, from the number M of same executable graphs, an optimized executable graph for the AI model inference by optimizing the one or more execution nodes in each of the number M of same executable graphs. Here, M may be an integer in a range of 2 to a maximum number N of allowed executable graphs, and N may be an integer manually configured or estimated based on a memory size of the inference device and a size of the executable graph.

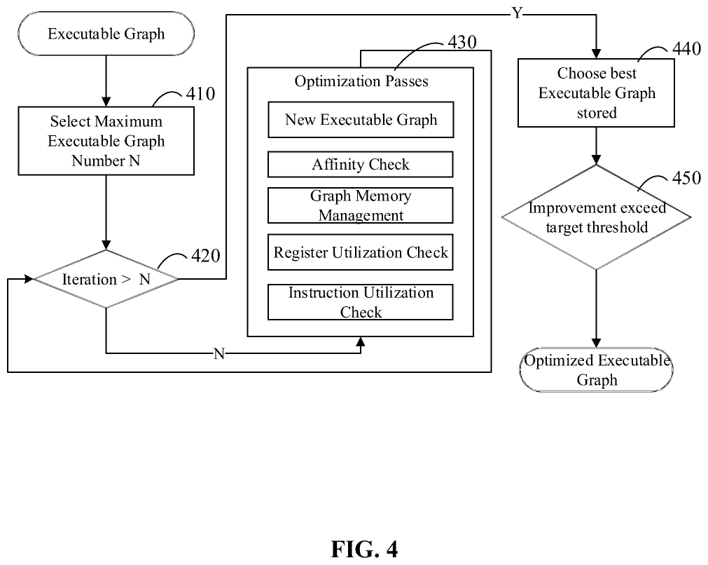

For better understanding the proposed solution for executable graph optimization, operations of the proposed executable graph optimizer will be described in detail with reference to FIG. 4, which illustrates an example flowchart of an executable graph optimization procedure according to some embodiments of the present disclosure.

First, at operation 410, a maximum number N of allowed executable graphs may be roughly estimated. For example, N may be estimated based on a memory size of an inference device to perform AI model inference and a size of an executable graph to be optimized. Alternatively, a user can also manually configure this parameter according to actual situations. Thus the maximum number N of allowed executable graphs may be determined as follows.

$$N = min ( ( int ) \frac{Device Memory Size}{Executable Graph Size} , Manually Configured value )$$

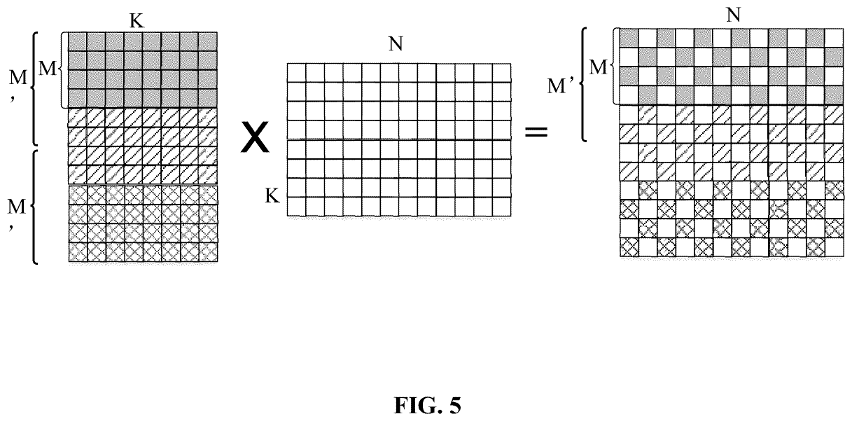

At operation 420, a number (N-) of iterations for executable graph optimization may start to be performed to find a best executable graph. Specifically, for a M-th iteration (1≤MSN), the executable graph may be duplicated to generate a number M of same executable graphs and the number M of same executable graphs may be subjected to operation 430 at which optimization passes may be performed on the combination of the number M of same executable graphs so as to generate a new executable graph. As shown in FIG. 4, the optimization passes performed at operation 430 may include instruction utilization check, register utilization check, graph memory management, affinity check and new executable graph generation, which will be described in detail with reference to FIG. 5 to FIG. 8.

In this way, by incrementing the number M from 2 to N, a number (N−1) of optimized executable graphs may be generated. At operation 440, a best optimized executable graph with a highest inference throughput may be chosen from the number (N−1) of optimized executable graphs and stored. For example, once a new executable graph is generated in a new iteration, the new executable graph may be compared with a stored executable graph with a currently highest inference throughput and replace the stored executable graph if an inference throughput associated with the new executable graph is better than the currently highest inference throughput, otherwise, the next iteration may be performed, until the N-th iteration is performed and accordingly the best optimized executable graph with the highest inference throughput is obtained.

After finishing the iterations, the best optimized executable graph and the corresponding number N′ (1<N′≤N) of executable graphs that have been combined to get the best optimized executable graph can be determined. As optimization passes in operation 430 may affect the memory shape and layer execution when generating the new executable graph from multiple graphs, latency and memory cost may change in order to improve the inference throughput, so a threshold may be set to measure whether it is worthwhile to improve the inference throughput by combining multiple executable graphs.

Accordingly, at operation 450, the highest inference throughput by use of the best optimized executable graph may be compared with a reference inference throughput. If an improvement of the highest inference throughput compared with the reference inference throughput is greater than a threshold, the best optimized executable graph may be output as the optimized executable graph for the AI model inference, otherwise, the previous single executable graph generated by the common executable graph optimizer may be still used for the AI model inference.

It is noted that for different numbers N′ (1<N′≤N) of executable graphs to be combined, the threshold could be different because different N′ has different influence on the latency and memory cost. For example, the inference throughput of the best optimized executable graph may be compared with a throughput of the AI model inference by use of the previous single executable graph in a batch mode with a batch size of N′, which is more challenging than a throughput of the AI model inference by use of the previous single executable graph in a normal mode. For example, for N′=2, the threshold may be set as 8%, and for N′=4, the threshold may be set as 15%. So, if the best optimized executable graph combined from four same executable graphs is selected as the optimized executable graph for the AI model inference, we expect at least a 15% improvement of the inference throughput compared with the inference throughput by use of the previous single executable graph in a batch mode with a batch size of 4.

An example procedure for executable graph optimization has been discussed above with reference to FIG. 4, but it is noted that not all of the operations in the example procedure are required to perform the executable graph optimization. In other words, some operations are provided to make the performance of the executable graph optimization better, but may be not included in the procedure or may be simplified or replaced with other operations. For example, according to some embodiments, the number of same executable graphs to be combined to obtain the optimized executable graphs may be predefined based on analysis of the processing capability of the inference device and the structure of the executable graph to be optimized. In this case, it may be not necessary to perform all the number (N−1) of iterations. For another example, the threshold for measuring the performance of the executable graph optimization at operation 450 may be determined in a different way or even the operation 450 for measuring the performance of the executable graph optimization may be omitted in specific usage scenarios.

Actually, as mentioned above, the basic idea of the proposed executable graph optimizer is to generate, from a specific number of same executable graphs, an optimized executable graph for AI model inference by optimizing one or more nodes eligible for optimization from the number of same executable graphs, which may be implemented by the optimization passes performed at operation 430 as shown in FIG. 4.

The optimization passes, such as instruction utilization check, register utilization check, graph memory management, affinity check and new executable graph generation, will be described below with reference to FIG. 5 to FIG. 8.

First, it is required to determine, from the executable graph, which nodes are eligible for optimization. In other words, the inference performance may be improved by optimizing these nodes. According to some embodiments, the instruction utilization and the register utilization at each node of the executable graph may be checked to determine whether the instruction utilization and the register utilization at the node reach a desired level according to the processing capability of the inference device, and the operation and the input and output data structure at the node.

A dimension size of input data for each node of the executable graph may directly impact efficiency of data loaded by a register, thereby affecting utilization of an instruction set. As shown in part (a) of FIG. 2, for the MatMul node, a shape of an input matrix A is 9×64 with a datatype of INT8. For the default executable graph, the MatMul kernel will use a configuration of M=9 for the TMM register when using TDPBUSD/TDPBUUD/TDPBSSD instructions. It may be highly wasteful if one instruction uses 3 TMM registers out of 8 TMM registers in total. Therefore, this node may be determined as a node eligible for optimization, and multiple same nodes from multiple same executable graphs may be merged to improve the instruction utilization, which is illustrated by FIG. 5. As shown in FIG. 5, by merging three MatMul nodes, the MatMul kernel may use a configuration of M′=16 for the TMM register, and thus the instruction utilization may be improved.

It is noted that the data size check may be performed from both the input and output perspectives, and any node in any layer of the executable graph that meets one of optimization conditions may be eligible for optimization. For the input perspective, if any key dimension size of input data at a node is smaller than a corresponding dimension size of input data determined by a SIMD instruction that consumes a lot of calculations and a datatype of the input data, the node may be eligible for optimization. For example, those computation intensive primitive kernels that use the VNNI instruction with the INT8 datatype may need to compare the input channel size with 4 and compare the output channel size with 16; those primitive kernels that use the TMUL instruction with the INT8 datatype may need to check whether M is smaller than16, K is smaller than 64 and N is smaller than 16; and those layers for quantization using the vfmadd213ps instruction with the FP32 datatype may need to check whether the input channel size is smaller than 16. In other words, the instruction utilization check may include comparing key dimension sizes of the input data and the output data at a node with corresponding dimension sizes of input data and output data determined by a SIMD instruction to be performed at the node and a datatype of the input data.

For example, for the input data of the node, the optimization condition may be represented by

$${Input}_{key \_ dimension} < \frac{Instrctuin\_simd \_length}{bit number determined by DataType} .$$

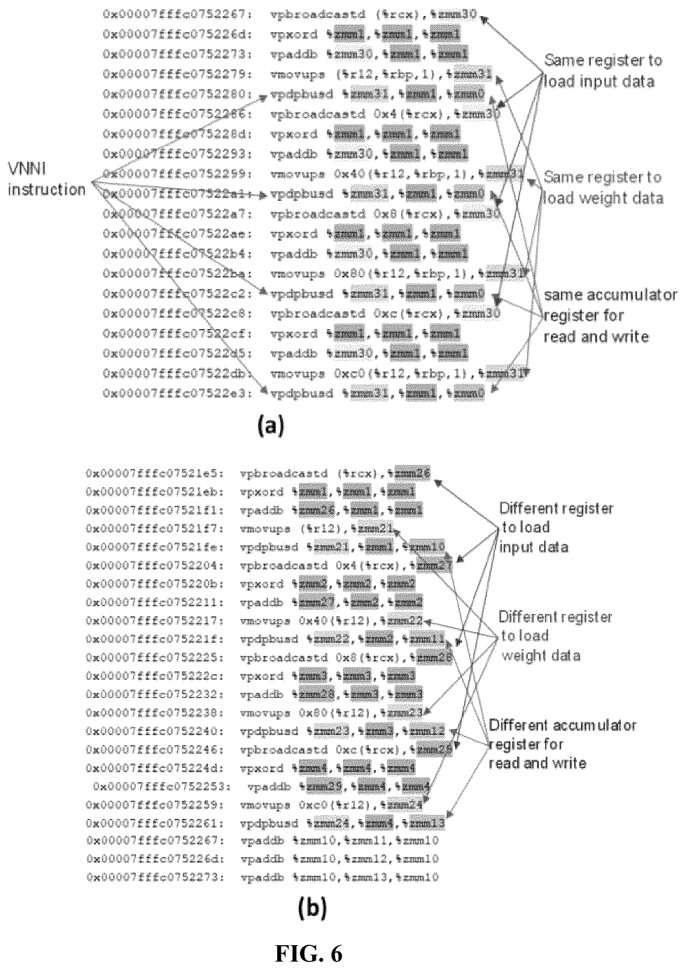

In addition to the instruction utilization check, the register utilization check may be performed to determine which nodes are eligible for optimization. In fact, the primitive implementation kernels often unroll on certain dimensions during implementations, such as input channel, output height or output width. The compiler may automatically generate the assembly code for execution. It is found that the generated assembly code includes repetition of an elementary code unit on an unroll dimension just as shown in FIG. 6. For most of register allocation strategies, if the unroll width is not enough, it will result in the problem of low register utilization problem shown in part (a) of FIG. 6.

Due to the insufficient unroll width, the elementary code unit can only use a small number of ZMM registers, and the rest registers will be idle. In the batch mode, although multiple input frames may be sent at once, the repetition of the elementary code unit remains unchanged just as shown in part (a) of FIG. 6. In contrast, for the optimized executable graph obtained by merging one or more nodes from multiple executable graphs, the node shape has changed. As the unroll width becomes larger, the elementary code unit can make full use of the ZMM registers to reduce instruction dependencies and improve parallelism as shown in part (b) of FIG. 6.

For example, for the convolution node on a CPU using the VNNI instruction set, three element registers may be used. Specifically, one register is used for input data, one register is used for weight data, and one register is used for output data. As the weight data is shared, the estimated number of elementary code units that can be executed in parallel by use of available registers (simply referred to as the estimated number of elementary code units herein) is (32−1)/2. For the quantization node, five element registers may be used, one for min value, one for max value, one for scale, one for bias, one for input data. Except the input data, other data involved at the quantization node, such as the min value, the max value, the scale and the bias, is shared by the same channel, so the estimated number of elementary code units is (32 −4)/1. For the MatMul node using AMX instructions, one register is used for input data A, one register is used for input data B and one register is used for output data. If the input data B is constant data, the estimated number of elementary code units is (8−1)/2. If the input data B is a variable, the estimated number of elementary code units is 8/3.

According to some embodiments, the register utilization check may be performed on an execution node to check if the register utilization of the elementary code unit on the execution node is less than a desired register utilization. If the register utilization of the elementary code unit on the execution node is less than the desired register utilization, it can be determined that the execution node is eligible for merging optimization so as to improve the register utilization. An example condition for the register utilization check may be represented by the following formula. In the formula, the left value means a value of unroll width on a key dimension of input data or output data at an execution node, such as the value of input channel, output channel, output width, or output height of the input data or output data, and the right value means the corresponding estimated number of elementary code units as described above.

$${UR}_{key \_ dimension} < \frac{Registers\_num}{E lement\_register \_num}$$

In fact, this is just a rough estimation for resource allocation. The real implementation of the convolution operation in OIhw4i16O4i format on CPU may be not exact, but the basic check can help to find the potential possibilities of improving the register utilization. Even if there is a little deviation, it doesn't matter as later passes will verify the real improvement for this optimization.

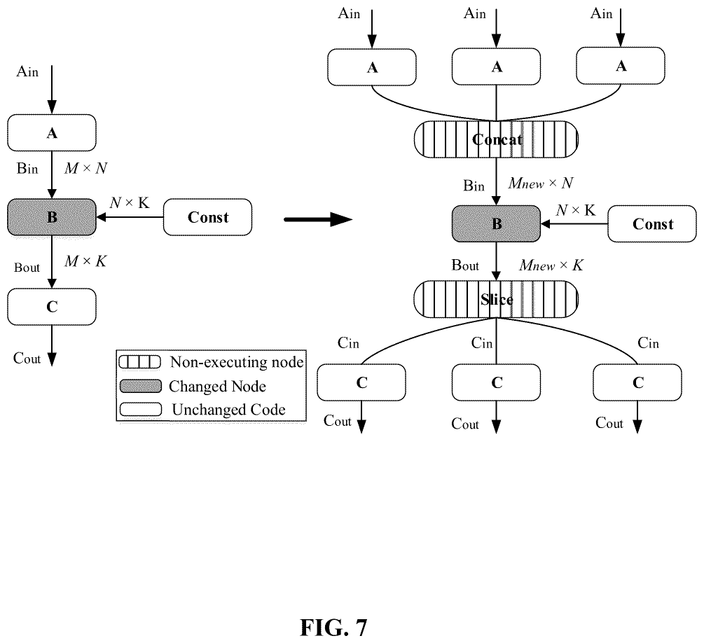

After finishing the above described instruction utilization check and register utilization check, the nodes eligible for optimization have been determined and the executable graph may be optimized by merging these nodes from multiple same executable graphs. FIG. 7 illustrates an example executable graph optimization process implemented by memory management and executable graph modification according to some embodiments of the present disclosure. According to the example executable graph optimization process in FIG. 7, it is assumed that the nodes A and C are temporarily not eligible for optimization, and the node B is eligible for optimization. The optimized node B in the new executable graph may have input and output memory of a new shape the same as multiple of that of the original node B. As shown in FIG. 7, some new “non-executing” layers that cost no computation are inserted before/after the optimized node into the new executable graph in order not to affect other nodes.

According to some embodiments, these “non-executing” layers may be generated by a memory manager for memory management, and will not be executed during runtime. For example, as the nodes A and C keep separate, a node Concat is added to merge the output memory of multiple nodes A to align with the input memory of the optimized node B. As the memory manager will allocate physically contiguous memory according to the size of the node B's input memory and each node A only needs the start address of the node B's input memory for output data to the node B, the Concat node doesn't need to be executed during runtime. Likewise, a node Slice is added to slice the output memory of the optimized node B to align with the input memory of multiple nodes C, and the Slice node doesn't need to be executed during runtime. When the optimized executable graph is sent to the inference device for performing the inference, all these “non-executing” nodes or layers will be removed as the primitive kernels only need the input and output buffers for computation and these assistant layers are useless during runtime.

As described above, the executable graph may be optimized by merging the nodes that are determined to be eligible for optimization based on the instruction utilization check and the register utilization check, so as to maximize the instruction utilization and the register utilization of the AI model inference on the inference device. In addition to the instruction utilization check and the register utilization check, as shown in FIG. 4, the optimization passes may include affinity check, which may be configured to check whether an affinity mode of a node should be modified from a frame affinity mode (i.e. a default affinity mode) to a layer affinity mode for reducing the cache miss rate.

Specifically, as most primitive kernels are implemented from the perspective of input data, if a size of the input data is not large enough or a size of constant data such as weight, scale, or bias are too large, cache miss introduced by load or store operations will play a more important role than the computation in the inference performance. Execution nodes involving operations with constant data, such as Quantization, Dequantization, Convolution and MatMul with input data of a small size, etc., all may face this issue. Maybe some nodes are determined to be not suitable for merging based on the instruction utilization check and the register utilization check, but these nodes may be eligible for optimization by modifying the affinity mode of these nodes to a layer affinity mode so as to reduce a cache miss rate.

For normal cases, the frame affinity mode may be better than the layer affinity mode since the output buffer of an execution node can be directly used by next execution nodes. However, for some execution nodes involving constant data, as the constant data is the same for each input frame, a layer affinity mode for execution nodes involving the constant data may be more effective than a default frame affinity mode due to a lower cache miss rate for loading the constant data. So after the above described instruction and register utilization checks and memory management, the affinity check may be performed on the optimized executable graph to determine a better affinity mode for certain execution nodes. Accordingly, the optimized executable graph may be further optimized by modifying the affinity mode of these execution nodes from the frame affinity mode to the layer affinity mode so as to reduce the cache miss rate and thus improve the overall inference throughput.

For example, the condition for determining a node eligible for optimization by modifying the affinity mode of the node may be represented as follows. That is, if the size of the constant data involved at the node is larger than a specified multiple y of the size of the input size, the node may be eligible for optimization by modifying the affinity mode of the node.

$$Const\_size > γ * Input\_size$$

According to some embodiments of the present disclosure, it is proposed to set the affinity mode of the nodes in the executable graph that meet the above condition to be the layer affinity mode. If the overall performance degrades, the affinity mode of the nodes may be reset to be the default frame affinity mode. As a result, according to the affinity mode setting and all the above merging optimizations, the shape of the executable graph may be changed and the memory for the nodes in the executable graph may be re-allocated.

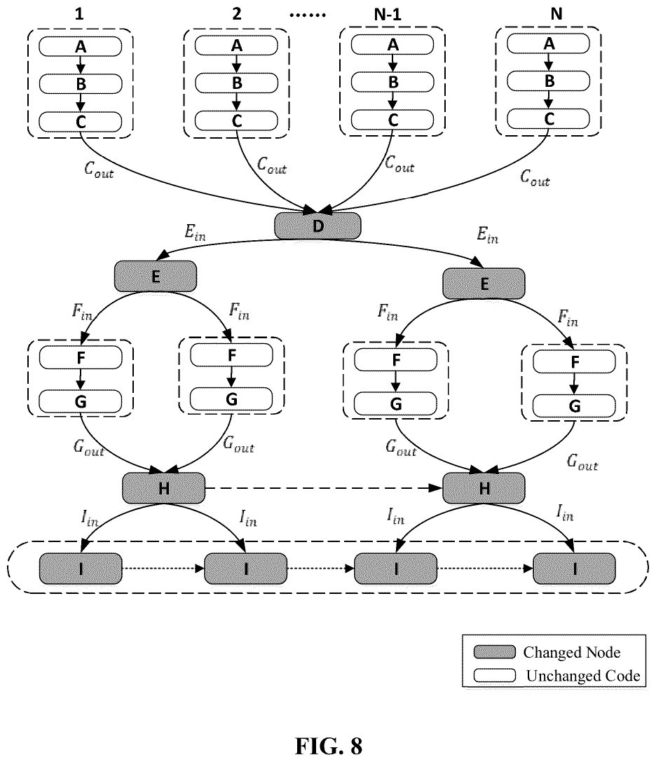

FIG. 8 illustrates an example optimized executable graph for AI model inference according to some embodiments of the present disclosure. The example optimized executable graph may be obtained after all the proposed optimization passes are performed on the executable graph output from the common executable graph optimizer. For example, as shown in FIG. 8, the nodes A, B, C and F, G keep in the frame affinity mode. All the original nodes D from the number N of same executable graphs are merged to generate the optimized node D, and new continuous memory are allocated for inputs and outputs of the optimized node D. Different from the single optimized node D, more than one optimized nodes E are generated according to characteristics of the primitive implementation kernel for executing the node E. That is, for a node eligible for merging, the node from each of a specified number of same executable graphs may be merged to generate an optimized node, or, the node from each of a subset of the specified number of same executable graphs may be merged to generate an optimized node. The nodes H are optimized in nearly the same way as the nodes E, but the affinity mode of the nodes H is configured as the layer affinity node, so the right node H is dependent on the left node H in the network topology, although there is actually no dependency, just to ensure that the nodes H are executed in the layer affinity mode. Similar to the nodes A, B, C, F and G, the node I is not suitable for merging optimization, but the layer affinity mode may be set for the nodes I to reduce the cache miss rate and thus achieve the better overall inference throughput.

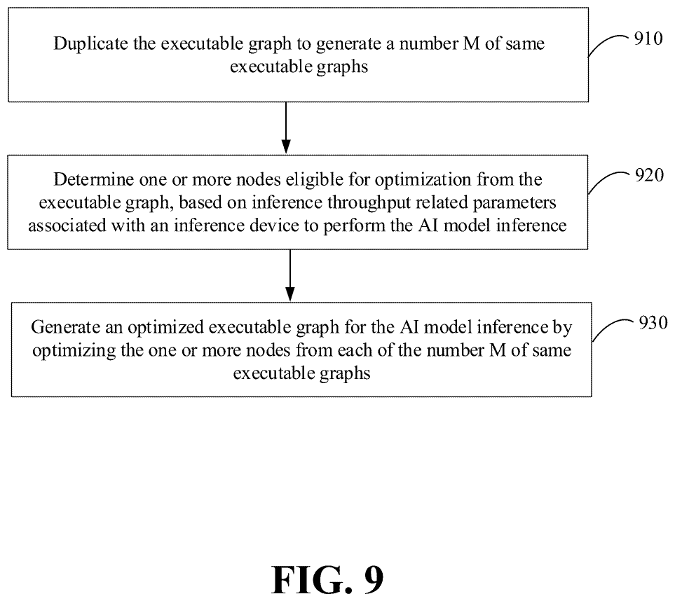

For better understanding an overall idea for optimization of an executable graph for AI model inference proposed in the disclosure, the proposed executable graph optimization procedure will be further described with reference to the flowchart shown in FIG. 9.

FIG. 9 illustrates an example flowchart of an executable graph optimization procedure according to some embodiments of the present disclosure. The executable graph optimization procedure may be implemented by a processor circuitry and may include operations 910 to 930.

At operation 910, the processor circuitry may duplicate the executable graph to generate a number M of same executable graphs. Here, M may be an integer in a range of 2 to a maximum number N of allowed executable graphs, and N may be an integer manually configured or estimated based on a memory size of the inference device and a size of the executable graph.

At operation 920, the processor circuitry may determine one or more nodes eligible for optimization from the executable graph, based on an inference throughput related parameter associated with an inference device to perform the AI model inference.

According to some embodiments, the inference throughput related parameter may include at least one of an instruction utilization, a register utilization and a cache miss rate.

At operation 930, the processor circuitry may generate an optimized executable graph for the AI model inference by optimizing the one or more nodes from each of the number M of same executable graphs.

According to some embodiments, the processor circuitry may generate the optimized executable graph by merging, for a node of the one or more nodes determined to be eligible for optimization based on the instruction utilization or the register utilization, the node from each of the number M of same executable graphs to generate an optimized node.

According to some embodiments, the processor circuitry may generate the optimized executable graph by merging, for a node of the one or more nodes determined to be eligible for optimization based on the instruction utilization or the register utilization, the node from each of a subset of the number M of same executable graphs to generate an optimized node.

According to some embodiments, the processor circuitry may generate the optimized executable graph by modifying, for a node of the one or more nodes determined to be eligible for optimization based on the cache miss rate, an affinity mode of the node from a frame affinity mode to a layer affinity mode to generate an optimized node for reducing the cache miss rate.

According to some embodiments, the processor circuitry may perform, by incrementing the number M from 2 to N, a number (N−1) of iterations each including duplicating the executable graph, determining the one or more nodes eligible for optimization and generating the optimized executable graph, to generate a number (N−1) of optimized executable graphs; and select, from the number (N−1) of optimized executable graphs, a best optimized executable graph with a highest inference throughput as the optimized executable graph.

According to some embodiments, the processor circuitry may determine whether an improvement of an inference throughput associated with the optimized executable graph as compared with a reference inference throughput is greater than a threshold; and transmit the optimized executable graph to the inference device, when it is determined that the improvement of the inference throughput associated with the optimized executable graph is greater than the threshold.

According to some embodiments, the processor circuitry may determine a number N′ of same executable graphs from which the optimized executable graph is generated, N′ being an integer in a range of 2 to N; and calculate an inference throughput of the AI model inference by use of the executable graph in a batch mode with a batch size of N′, as the reference inference throughput.

According to some embodiments, the processor circuitry may insert, before or after the optimized node, one or more nodes for performing memory management associated with the optimized node; and mark the one or more nodes for performing memory management as non-executing nodes to be removed from the optimized executable graph during runtime of the optimized executable graph on the inference device.

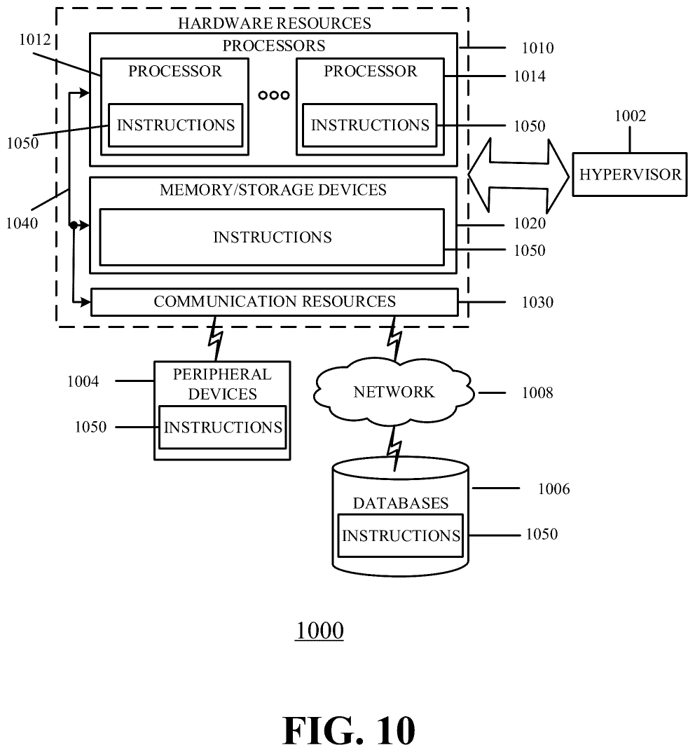

FIG. 10 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 10 shows a diagrammatic representation of hardware resources 1000 including one or more processors (or processor cores) 1010, one or more memory/storage devices 1020, and one or more communication resources 1030, each of which may be communicatively coupled via a bus 1040. For embodiments where node virtualization (e.g., NFV) is utilized, a hypervisor 1002 may be executed to provide an execution environment for one or more network slices/sub-slices to utilize the hardware resources 1000.

The processors 1010 may include, for example, a processor 1012 and a processor 1014 which may be, e.g., a central processing unit (CPU), a graphics processing unit (GPU), a tensor processing unit (TPU), a visual processing unit (VPU), a field programmable gate array (FPGA), or any suitable combination thereof.

The memory/storage devices 1020 may include main memory, disk storage, or any suitable combination thereof. The memory/storage devices 1020 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1030 may include interconnection or network interface components or other suitable devices to communicate with one or more peripheral devices 1004 or one or more databases 1006 via a network 1008. For example, the communication resources 1030 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1050 may comprise software, a program, an application, an applet, an app, or other executable code for causing at least any of the processors 1010 to perform any one or more of the methodologies discussed herein. The instructions 1050 may reside, completely or partially, within at least one of the processors 1010 (e.g., within the processor's cache memory), the memory/storage devices 1020, or any suitable combination thereof. Furthermore, any portion of the instructions 1050 may be transferred to the hardware resources 1000 from any combination of the peripheral devices 1004 or the databases 1006. Accordingly, the memory of processors 1010, the memory/storage devices 1020, the peripheral devices 1004, and the databases 1006 are examples of computer-readable and machine-readable media.

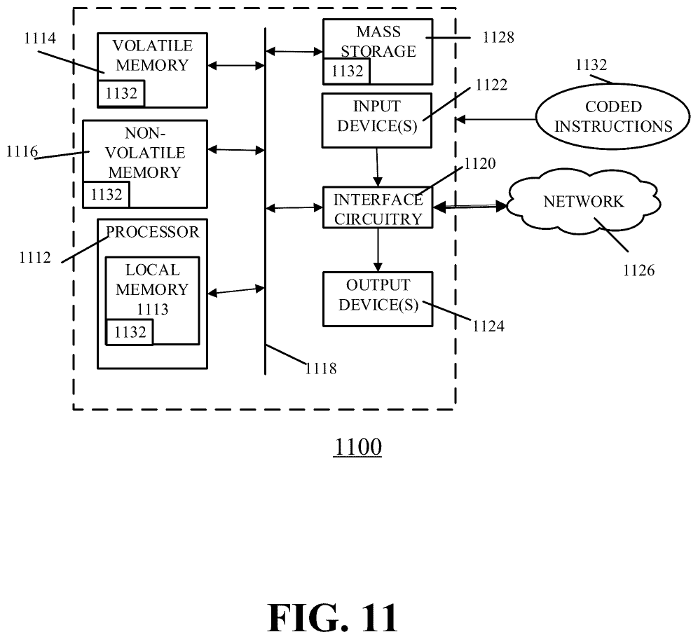

FIG. 11 is a block diagram of an example processor platform in accordance with some embodiments of the disclosure. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 1100 of the illustrated example includes a processor 1112. The processor 1112 of the illustrated example is hardware. For example, the processor 1112 can be implemented by one or more integrated circuits, logic circuits, microprocessors, GPUs, DSPs, or controllers from any desired family or manufacturer. The hardware processor may be a semiconductor based (e.g., silicon based) device. In some embodiments, the processor implements one or more of the methods or processes described above.

The processor 1112 of the illustrated example includes a local memory 1113 (e.g., a cache). The processor 1112 of the illustrated example is in communication with a main memory including a volatile memory 1114 and a non-volatile memory 1116 via a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1116 may be implemented by flash memory and/or any other desired type of memory device. Access to the main memory 1114, 1116 is controlled by a memory controller.

The processor platform 1100 of the illustrated example also includes interface circuitry 1120. The interface circuitry 1120 may be implemented by any type of interface standard, such as an Ethernet interface, a universal serial bus (USB), a Bluetooth® interface, a near field communication (NFC) interface, and/or a PCI express interface.

In the illustrated example, one or more input devices 1122 are connected to the interface circuitry 1120. The input device(s) 1122 permit(s) a user to enter data and/or commands into the processor 1112. The input device(s) can be implemented by, for example, an audio sensor, a microphone, a camera (still or video), a keyboard, a button, a mouse, a touchscreen, a track-pad, a trackball, and/or a voice recognition system.

One or more output devices 1124 are also connected to the interface circuitry 1120 of the illustrated example. The output devices 1124 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuitry 1120 of the illustrated example, thus, typically includes a graphics driver card, a graphics driver chip and/or a graphics driver processor.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1126. The communication can be via, for example, an Ethernet connection, a digital subscriber line (DSL) connection, a telephone line connection, a coaxial cable system, a satellite system, a line-of-site wireless system, a cellular telephone system, etc.

For example, the interface circuitry 1120 may include a training dataset inputted through the input device(s) 1122 or retrieved from the network 1126.

The processor platform 1100 of the illustrated example also includes one or more mass storage devices 1128 for storing software and/or data. Examples of such mass storage devices 1128 include floppy disk drives, hard drive disks, compact disk drives, Blu-ray disk drives, redundant array of independent disks (RAID) systems, and digital versatile disk (DVD) drives.

Machine executable instructions 1132 may be stored in the mass storage device 1128, in the volatile memory 1114, in the non-volatile memory 1116, and/or on a removable non-transitory computer readable storage medium such as a CD or DVD.

### ADDITIONAL NOTES AND EXAMPLES

Example 1 includes an apparatus for optimization of an executable graph for artificial intelligence (AI) model inference, comprising: interface circuitry; and processor circuitry coupled to the interface circuitry and configured to: duplicate the executable graph received via the interface circuitry to generate a number M of same executable graphs; determine one or more nodes eligible for optimization from the executable graph, based on an inference throughput related parameter associated with an inference device to perform the AI model inference; and generate an optimized executable graph for the AI model inference by optimizing the one or more nodes from each of the number M of same executable graphs, wherein M is an integer in a range of 2 to a maximum number N of allowed executable graphs, and N is an integer manually configured or estimated based on a memory size of the inference device and a size of the executable graph.

Example 2 includes the apparatus of Example 1, wherein the processor circuitry is further configured to: perform, by incrementing the number M from 2 to N, a number (N−1) of iterations each including duplicating the executable graph, determining the one or more nodes eligible for optimization and generating the optimized executable graph, to generate a number (N−1) of optimized executable graphs; and select, from the number (N−1) of optimized executable graphs, a best optimized executable graph with a highest inference throughput as the optimized executable graph.

Example 3 includes the apparatus of Example 1 or 2, wherein the processor circuitry is further configured to: determine whether an improvement of an inference throughput associated with the optimized executable graph as compared with a reference inference throughput is greater than a threshold; and provide the optimized executable graph to the interface circuitry for transmission to the inference device, when it is determined that the improvement of the inference throughput associated with the optimized executable graph is greater than the threshold.

Example 4 includes the apparatus of Example 3, wherein the processor circuitry is further configured to: determine a number N′ of same executable graphs from which the optimized executable graph is generated, N′ being an integer in a range of 2 to N; and calculate an inference throughput of the AI model inference by use of the executable graph in a batch mode with a batch size of N′, as the reference inference throughput.

Example 5 includes the apparatus of any of Examples 1 to 4, wherein the inference throughput related parameter comprises at least one of an instruction utilization, a register utilization and a cache miss rate.

Example 6 includes the apparatus of Example 5, wherein the processor circuitry is configured to generate the optimized executable graph for the AI model inference by: merging, for a node of the one or more nodes determined to be eligible for optimization based on the instruction utilization or the register utilization, the node from each of the number M of same executable graphs to generate an optimized node.

Example 7 includes the apparatus of Example 5, wherein the processor circuitry is configured to generate the optimized executable graph for the AI model inference by: merging, for a node of the one or more nodes determined to be eligible for optimization based on the instruction utilization or the register utilization, the node from each of a subset of the number M of same executable graphs to generate an optimized node.

Example 8 includes the apparatus of Example 5, wherein the processor circuitry is configured to generate the optimized executable graph for the AI model inference by: modifying, for a node of the one or more nodes determined to be eligible for optimization based on the cache miss rate, an affinity mode of the node from a frame affinity mode to a layer affinity mode to generate an optimized node for reducing the cache miss rate.

Example 9 includes the apparatus of Example 6 or 7, wherein the processor circuitry is further configured to: insert one or more nodes for performing memory management associated with the optimized node; and mark the one or more nodes for performing memory management as non-executing nodes to be removed from the optimized executable graph during runtime of the optimized executable graph on the inference device.

Example 10 includes a method for optimization of an executable graph for artificial intelligence (AI) model inference, comprising: duplicating the executable graph to generate a number M of same executable graphs; determining one or more nodes eligible for optimization from the executable graph, based on an inference throughput related parameter associated with an inference device to perform the AI model inference; and generating an optimized executable graph for the AI model inference by optimizing the one or more nodes from each of the number M of same executable graphs, wherein M is an integer in a range of 2 to a maximum number N of allowed executable graphs, and N is an integer manually configured or estimated based on a memory size of the inference device and a size of the executable graph.

Example 11 includes the method of Example 10, further comprising: performing, by incrementing the number M from 2 to N, a number (N−1) of iterations each including duplicating the executable graph, determining the one or more nodes eligible for optimization and generating the optimized executable graph, to generate a number (N−1) of optimized executable graphs; and selecting, from the number (N−1) of optimized executable graphs, a best optimized executable graph with a highest inference throughput as the optimized executable graph.

Example 12 includes the apparatus of Example 10 or 11, further comprising: determining whether an improvement of an inference throughput associated with the optimized executable graph as compared with a reference inference throughput is greater than a threshold; and transmitting the optimized executable graph to the inference device, when it is determined that the improvement of the inference throughput associated with the optimized executable graph is greater than the threshold.

Example 13 includes the apparatus of Example 12, further comprising: determining a number N′ of same executable graphs from which the optimized executable graph is generated, N′ being an integer in a range of 2 to N; and calculating an inference throughput of the AI model inference by use of the executable graph in a batch mode with a batch size of N′, as the reference inference throughput.

Example 14 includes the method of any of Examples 10 to 13, wherein the inference throughput related parameter comprises at least one of an instruction utilization, a register utilization and a cache miss rate.

Example 15 includes the method of Example 14, wherein generating the optimized executable graph for the AI model inference comprises: merging, for a node of the one or more nodes determined to be eligible for optimization based on the instruction utilization or the register utilization, the node from each of the number M of same executable graphs to generate an optimized node.

Example 16 includes the method of Example 14, wherein generating the optimized executable graph for the AI model inference comprises: merging, for a node of the one or more nodes determined to be eligible for optimization based on the instruction utilization or the register utilization, the node from each of a subset of the number M of same executable graphs to generate an optimized node.

Example 17 includes the method of Example 14, wherein generating the optimized executable graph for the AI model inference comprises: modifying, for a node of the one or more nodes determined to be eligible for optimization based on the cache miss rate, an affinity mode of the node from a frame affinity mode to a layer affinity mode to generate an optimized node for reducing the cache miss rate.

Example 18 includes the method of Example 15 or 16, further comprising: inserting one or more nodes for performing memory management associated with the optimized node; and marking the one or more nodes for performing memory management as non-executing nodes to be removed from the optimized executable graph during runtime of the optimized executable graph on the inference device.

Example 19 includes a computer-readable medium having instructions stored thereon, wherein the instructions, when executed by processor circuitry, cause the processor circuitry to perform any method of Examples 10 to 18.

Example 20 includes an apparatus, comprising means for performing any method of Examples 10 to 18.

Various techniques, or certain aspects or portions thereof, may take the form of program code (i.e., instructions) embodied in tangible media, such as floppy diskettes, CD-ROMs, hard drives, non-transitory computer readable storage medium, or any other machine-readable storage medium, wherein, when the program code is loaded into and executed by a machine, such as a computer, the machine becomes an apparatus for practicing the various techniques. The non-transitory computer readable storage medium may be a computer readable storage medium that does not include signal. In the case of program code execution on programmable computers, the computing system may include a processor, a storage medium readable by the processor (including volatile and non-volatile memory and/or storage elements), at least one input device, and at least one output device. The volatile and non-volatile memory and/or storage elements may be a RAM, EPROM, flash drive, optical drive, magnetic hard drive, solid state drive, or other medium for storing electronic data. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations. Exemplary systems or devices may include without limitation, laptop computers, tablet computers, desktop computers, smart phones, computer terminals and servers, storage databases, and other electronics which utilize circuitry and programmable memory, such as household appliances, smart televisions, digital video disc (DVD) players, heating, ventilating, and air conditioning (HVAC) controllers, light switches, and the like.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1-20. (canceled)

21. An apparatus for optimization of an executable graph for artificial intelligence (AI) model inference, the apparatus comprising:
interface circuitry;
instructions; and
at least one processor circuit to be programmed based on the instructions to:
duplicate the executable graph received via the interface circuitry to generate a number M of same executable graphs;
determine one or more nodes eligible for optimization from the executable graph, the determination based on an inference throughput related parameter associated with an inference device to perform the AI model inference; and
generate an optimized executable graph for the AI model inference based on optimization of the one or more nodes from each of the number M of same executable graphs,
wherein M is an integer in a range of 2 to a maximum number N of allowed executable graphs, and N is an integer that is at least one of configured or estimated based on a memory size of the inference device and a size of the executable graph.

22. The apparatus of claim 21, wherein one or more of the at least one processor circuit is to:
perform, by incrementing the number M from 2 to N, a number (N−1) of iterations to generate a number (N−1) of optimized executable graphs, respective one of the iterations including duplicating the executable graph, determining the one or more nodes eligible for optimization and generating the optimized executable graph; and
select, from the number (N−1) of optimized executable graphs, a best optimized executable graph with a highest inference throughput as the optimized executable graph.

23. The apparatus of claim 21, wherein one or more of the at least one processor circuit is to:
determine whether an improvement of an inference throughput associated with the optimized executable graph as compared with a reference inference throughput is greater than a threshold; and
provide the optimized executable graph to the interface circuitry for transmission to the inference device based on a determination that the improvement of the inference throughput associated with the optimized executable graph is greater than the threshold.

24. The apparatus of claim 23, wherein one or more of the at least one processor circuit is to:
determine a number N′ of same executable graphs from which the optimized executable graph is generated, N′ being an integer in a range of 2 to N; and
calculate an inference throughput of the AI model inference by use of the executable graph in a batch mode with a batch size of N′, as the reference inference throughput.

25. The apparatus of claim 21, wherein the inference throughput related parameter includes at least one of an instruction utilization, a register utilization or a cache miss rate.

26. The apparatus of claim 25, wherein one or more of the at least one processor circuit is to generate the optimized executable graph for the AI model inference by:
merging, for a node of the one or more nodes determined to be eligible for optimization based on the instruction utilization or the register utilization, the node from each of the number M of same executable graphs to generate an optimized node.

27. The apparatus of claim 25, wherein one or more of the at least one processor circuit is to generate the optimized executable graph for the AI model inference by:
merging, for a node of the one or more nodes determined to be eligible for optimization based on the instruction utilization or the register utilization, the node from each of a subset of the number M of same executable graphs to generate an optimized node.

28. The apparatus of claim 25, wherein one or more of the at least one processor circuit is to generate the optimized executable graph for the AI model inference by:
modifying, for a node of the one or more nodes determined to be eligible for optimization based on the cache miss rate, an affinity mode of the node from a frame affinity mode to a layer affinity mode to generate an optimized node for reducing the cache miss rate.

29. The apparatus of claim 26, wherein one or more of the at least one processor circuit is to:
insert one or more nodes for performing memory management associated with the optimized node; and
mark the one or more nodes for performing memory management as non-executing nodes to be removed from the optimized executable graph during runtime of the optimized executable graph on the inference device.

30. A method for optimization of an executable graph for artificial intelligence (AI) model inference, the method comprising:
duplicating the executable graph to generate a number M of same executable graphs;
determining one or more nodes eligible for optimization from the executable graph, the determining based on an inference throughput related parameter associated with an inference device to perform the AI model inference; and
generating an optimized executable graph for the AI model inference based on optimization of the one or more nodes from each of the number M of same executable graphs,
wherein M is an integer in a range of 2 to a maximum number N of allowed executable graphs, and N is an integer that is at least one of configured or estimated based on a memory size of the inference device and a size of the executable graph.

31. The method of claim 30, including:
performing, by incrementing the number M from 2 to N, a number (N−1) of iterations to generate a number (N−1) of optimized executable graphs, respective ones of the iterations including duplicating the executable graph, determining the one or more nodes eligible for optimization and generating the optimized executable graph; and
selecting, from the number (N−1) of optimized executable graphs, a best optimized executable graph with a highest inference throughput as the optimized executable graph.

32. The method of claim 30, including:
determining whether an improvement of an inference throughput associated with the optimized executable graph as compared with a reference inference throughput is greater than a threshold; and
transmitting the optimized executable graph to the inference device based on a determination that the improvement of the inference throughput associated with the optimized executable graph is greater than the threshold.

33. The method of claim 32, including:
determining a number N′ of same executable graphs from which the optimized executable graph is generated, N′ being an integer in a range of 2 to N; and
calculating an inference throughput of the AI model inference by use of the executable graph in a batch mode with a batch size of N′, as the reference inference throughput.

34. The method of claim 30, wherein the inference throughput related parameter includes at least one of an instruction utilization, a register utilization and a cache miss rate.

35. A non-transitory computer-readable medium comprising instructions to cause at least one processor circuit to at least:
duplicate an executable graph to generate a number M of same executable graphs, the executable graph for artificial intelligence (AI) model inference;
determine one or more nodes eligible for optimization from the executable graph, the determining based on an inference throughput related parameter associated with an inference device to perform the AI model inference; and
generate an optimized executable graph for the AI model inference based on optimization of the one or more nodes from each of the number M of same executable graphs,
wherein M is an integer in a range of 2 to a maximum number N of allowed executable graphs, and N is an integer that is at least one of configured or estimated based on a memory size of the inference device and a size of the executable graph.

36. The computer-readable medium of claim 35, wherein the instructions are to cause one or more of the at least one processor circuit to:
perform, by incrementing the number M from 2 to N, a number (N−1) of iterations to generate a number (N−1) of optimized executable graphs, respective ones of the iterations including duplicating the executable graph, determining the one or more nodes eligible for optimization and generating the optimized executable graph; and
select, from the number (N−1) of optimized executable graphs, a best optimized executable graph with a highest inference throughput as the optimized executable graph.

37. The computer-readable medium of claim 35, wherein the instructions are to cause one or more of the at least one processor circuit to:
determine whether an improvement of an inference throughput associated with the optimized executable graph as compared with a reference inference throughput is greater than a threshold; and
cause transmission of the optimized executable graph to the inference device based on a determination that the improvement of the inference throughput associated with the optimized executable graph is greater than the threshold.

38. The computer-readable medium of claim 37, wherein the instructions are to cause one or more of the at least one processor circuit to:
determining a number N′ of same executable graphs from which the optimized executable graph is generated, N′ being an integer in a range of 2 to N; and
calculating an inference throughput of the AI model inference by use of the executable graph in a batch mode with a batch size of N′, as the reference inference throughput.

39. The computer-readable medium of claim 35, wherein the inference throughput related parameter includes at least one of an instruction utilization, a register utilization and a cache miss rate.

40. The computer-readable medium of claim 39, wherein the instructions are to cause one or more of the at least one processor circuit to merge, for a node of the one or more nodes determined to be eligible for optimization based on the instruction utilization or the register utilization, the node from each of the number M of same executable graphs to generate an optimized node.
